(19) United States
(12) Patent Application Publication
(10) Pub. No.: US 2025/0092981 A1
(43) Pub. Date: Mar. 20, 2025

(54) Method of cleaning pipeline interior with self-destructive cleaning device

(71) Applicant: Olexandr Cheptsov, Kyiv (UA)

(72) Inventor: Olexandr Cheptsov, Kyiv (UA)

(21) Appl. No.: 18/121,076

(22) Filed: Mar. 14, 2023

(51) Int. Cl. F16L 55/42; F16L 101/12

(52) U.S. Cl. CPC F16L 55/42; F16L 2101/12

(57) ABSTRACT

Pipeline interiors is cleaned by passing through a self-destructive device, which has structure of hybrid physical (thermoreversible) hydrogel of polyelectrolyte and its complexes with salt ions. The melting temperature of the device is lower than the temperature in the pipeline, which ensures its destruction in an event of a stoppage, as well as an cleaning possibility without the use of receiving chambers. An operational time of the device is regulated by structure of material at manufacturing stage and can be additionally increased by cooling before launching, which makes it possible to use a batch of devices of the same composition in pipelines of different lengths. After launching, over time, temperature of the device rises and transition of the material into a viscous-fluid state occurs—transformation into a liquid. Highly concentrated hydrogel makes it possible to manufacture devices in the form of a bullet with a central, longitudinal through channel in body, which improves the quality of interior cleaning and guarantees the destruction of the device in the pipeline. The method of device manufacturing includes the preparation of forming mixture by dissolving in some polar solvent under conditions of mixing and heating some electrolyte and polyelectrolyte, as a result of reaction between them formation of complexes, pouring the forming mixture into casting molds, cooling and holding the mixture until the product is obtained.

Use self-destructive pigs in gas fields looks promising in gathering pipelines during period of falling gas production, at underground gas storages, at field of production in offshore areas, water pipelines and distribution networks, also in many field activities with use of piping transport.

### FIELD OF THE INVENTION

### Background of the Invention

Operation of pipeline systems requires periodic cleaning of interiors to remove various

This invention relates to a method of cleaning pipeline interior with self-destructive cleaning device, design of device and its manufacturing mode.

deposits, corrosion products, water condensate in gas gathering pipelines at gas productions and underground storage facilities. Pipeline interior cleaning is also fulfiled after completion of construction of new mains and their tightness testing under water pressure ( [symbol] , 1972).

The most effective technology of pipeline interior cleaning involves passage of a cleaning device through pipeline. There are large number of mechanical devices (rigid, elastic) for pipeline cleaning, which ensure destruction and removal of deposits from inner surface during motion along pipes under pressure of fluid (The Art of Pigging, 1998).

Pigs are made of elastic materials pass narrowing places of pipeline better than rigid, turns of small radius, so it stops rarely. Developments were also carried out in direction of increasing strength of elastic materials of cleaning devices by using of crosslinked gels (R. J. Purinton, U.S. Pat. No. 4,543,131A), foamed polymers filled with gel (Scott P. R., U.S. Pat. No. 4,389,461A), crystalline gels with plasticizers (Chen J. H., U.S. Pat. No. 6,117,176A), and so on. Use of flexible devices significantly reduce number of clogging of pipelines in comparison with rigid devices, in which is using of metal parts for frame. Launcher and receiving chambers ( [symbol] , 1974) are used to introduction, start cleaning pigs into pipelines and its removing from ones. Camera units are quite complex and expensive, while need is significant for them. For example, at main pipelines, chambers must be installed in each section before entry of gas, oil or water into injection apparatus (compressors, pumps) and after outlet of current from them.

In addition to need to use pig launcher-receive chambers, this technology has another significant disadvantage in form existence of potential problem of clogging of pipeline interiors with mechanical cleaning devices. There are many reasons for this phenomenon, namely: shortcomings of pipeline system (installation defects, changes in pipe diameters along line, differences in internal diameters of pipes and shut-off valves, etc.), accumulation of solid deposits in pipeline interiors, design defects of cleaning devices and many others. Elimination of blockage of pipelines by devices is associated with significant economic losses (pipeline stoppage, determining stoppage place of devices, cutting pipe with removal of device, restoration of pipeline, etc.). For facilitate search a stop place of pig an alarm set in its body before launching. However, determining position of device stuck with help of search equipment does not eliminate need to remove blockages with above-mentioned losses.

The shortcomings of this pipeline cleaning technology mean that it is not used at all without number of objects.

There is also a method of cleaning pipeline interior with a gas hydrate pig, which is removed from a system by its decomposition to water and gas after work completion ( [symbol] , A. C. ABT. CB. CCCP No860899). Adjustment of time of serviceability of the pig is implemented by means of introduction of inhibitors in hydrate at stage of device manufacture, which allows conduct purification process without using of receive chambers. This type of cleaning device is called mechanical (rigid) with a specified duration of action. A new approach is formulated to solving problem of cleaning devices manufacturing from self-destructing materials in a report ( [symbol] A. C., 1981). The term “self-destroying” concerns a material that retains mechanical strength in a transported product during specified period of time at technological parameters of cleaning process, after that it is destroyed. The material of the gas hydrate pig is self-destroying, but its main disadvantage is difficulty of obtaining gas hydrates and formation of devices, also it's not flexible enough.

There is a method and an apparatus for production of self-destroying elastic pigs from a composite material which forms by contact of gas, that can generate gas hydrates, and aqueous solution of polymers and salts with cooling ( [symbol] , A. C., PΦ [symbol] No1838004; [symbol] A. C. [symbol] ., PΦ [symbol] No1769994). Disadvantage of this technology, as well as above-mentioned, is difficulty of regulating gas hydrate amount in the material, which is responsible for destroying of the pig and its service life, and need to use equipment under excess pressure.

Gels in form of high-viscosity liquids can be used to collect and remove various deposits from pipeline interiors through open end. It was reported about cleaning of the 453-km long underwater gas pipeline with a liquid non-toxic polysaccharide in form of plugs separated by mechanical scrapers (Scott P. R., 1982). The use of mechanical scrapers prevents some debris from passing near the outer surface of the gel plug and remaining in the pipeline.

A large number of polymers (natural and artificial) are able to form gels from solution. In dependence upon nature of solvent it distinguishes aqueous (U.S. Pat. Nos. 4,543,131; 4,416,703) and organic gels (U.S. Pat. Nos. 4,003,393; 4,473,408). Gels are subjected to chemical sewing to improve physical and mechanical parameters. A large list of patents relating to gels and their use are given in afore-cited patents (“Other patents” and “References to this patent” lists).

It should be noted that use of gel pigs as cleaners as well as mechanical cleaners requires presence of launching and receiving chambers in the section of the pipeline that need cleaning.

It is also known a method of cleaning channels (pipelines) using a gelatin gel pig (U.S. Pat. No. 5,300,151). At stage of its production, a destructive ingredient enzyme (pepsin enzyme) is added to gelatin for biodegradation, for example baker's yeast. By design, the pig is capable of biodegradation and disintegration, which allows cleaning of pipeline without the use of expensive stationary receiving chambers as well as launching, if is a compartment for manufacture of the pig. The low strength of the gelatin gel makes it necessary to strengthen the pig, that generally contradicts need for its further destruction. Therefore, it is suggested to fix only its outer layer up to ¼ inch by air drying or formaldehyde treatment.

The results of laboratory tests of material samples under conditions of heating at the temperature of 83° F. (28° C.) for 76.5 hours do not look convincing, but on the contrary give doubts regarding the possibility of wide practical use of this pig destruction mechanism.

The fact is that the vast majority of pipelines concentrated in such industries as gas production, utilities, etc., have a section length of no more than 3-5 km. The time of movement of the pig at such areas will not exceed 2 hours, and so required time of a pig's serviceability should be 40 times less than the time of exposure of samples in the test. In addition, to accelerate destruction of samples by elevated temperature was used as an activator, which is not typical for operating conditions of the vast majority of objects. If the pig does not collapse during time of motion till reaching the end point of the pipeline section, an emergency situation will arise as a result of clogging of the interior.
There is also a question about the feasibility of the operation of introducing yeast into the gelatin solution before it is cooled. According to the patent formula the temperature of the gelatin solution is 170° F. (76° C.), and above 45-50° C. the yeast dies.

Thus, it can be concluded that the problem of self-destruction is not solved and remains essentially only declared.

A method of cleaning channels according to (U.S. Pat. No. 5,300,152) differs from the previous one only strengthening of the device surface with freezing.

A method of cleaning pipelines according to (U.S. Pat. No. 6,485,577) is performed using a pig produced by freezing portion of the product, which is transported. A solid pig has a lot of operational disadvantages and its use is not effective.

Soap-based devices are also known, which are intended to remove water from gas pipelines by foaming, for example (U.S. Pat. No. 6,802,909B1). Such devices are water-soluble and can also perform anti-corrosion, anti-bacterial protection of pipes due to formation of protective film on the inner surface; at the same time soaps are capable of biodegradation. Shape of the devices can be spherical, cylindrical, and cameras are required for their launching. But such devices cannot perform role of a scraper, because their dissolution begins from the very beginning of their stay in the interior.

### BRIEF SUMMARY OF THE INVENTION

This invention provides a method of scraping and cleaning pipeline interior with hydrogel cleaning device and its construction for use in said cleaning method, as well as a method of manufacturing devices.

Melting temperature of the device is lower than temperature in pipeline which is cleaning, that ensures its destruction in event of stoppage, as well as cleaning possibility without using of receiving chambers.

The cleaning devices is formed in such size that correspond to diameter of pipeline interior, ensures contact with its surface and cuts sediment deposits of pollution during movement. Impurities (or liquid) are removed and pushed to end of said pipeline; both destruction and dissolution of the device occur, and device remains together with impurities and liquid are move away from linear part.

More specifically, the structure of the device consists of hybrid (thermo-reversible) hydrogel of polyelectrolyte and its complexes with salt ions, which contents inclusions of polar solvent with polyelectrolyte and salts. If necessary, increase of a service life of the cleaning device is achieved by a degree of its supercooling relatively to melting temperature of hydrogel.

The device can be moved to the launching (stationary) chamber after completion of its production in a casting mold to do cleaning of pipeline,

Also a pig can be launched from the pipeline compartment in which its formation is implemented. The compartment for formation of the pig at the launch site in is equipped with casing so that to use artificial cold.

Thus, with the use of self-destructing devices it is possible to clean sections of pipelines that do not have stationary chambers at all-neither launching nor receiving.

In order to increase reliability and efficiency of cleaning, the structure of the cleaning device consists of the above-mentioned hybrid hydrogel of high concentration, and a body is made in shape of a bullet that is equipped with central longitudinal through channel, diameter of which narrows in direction from rear end to nose part. In contrast to liquid gels, the highly concentrated gel provides possibility of scrape cleaning, as well as possibility of creating the channel in the body and maintaining the required shape and of its service life.

During movement part of transported fluid flows from space behind the device to space in front of nose part. The flow in the channel makes possibility to influence on rate of heating of its body in the direction from center to periphery, and therefore rate of destruction both due to melting and erosion. In a case of using a solid pig, when it reaches the end of linear part of pipeline section that is subject to cleaning, but does not reach complete melting, it's possible clogging of the interior. Therefore, the presence of the channel in the self-destructing pig increases reliability of the cleaning method due to additional effect on its service life.

In addition, jet from nose part of the pig does not allow sediment particles to become clogged, which can cause blocking of pipeline. The flow maintains sediment particles in the form of a suspension, that prevents blocking of the pipeline and, even more, contributes to better cleaning of internal surface due to hydromechanical effect.

This invention also includes a method of manufacturing devices in which take place sequential gradual dissolution in a polar solvent under stirring conditions of a low molecular weight electrolyte and polyelectrolyte; a result of carried out a reaction is forming mixture from solvent, interaction products of polyelectrolyte and salt ions that is complexes, polyelectrolyte, electrolyte, and subsequent pouring of forming mixture into casting molds, which allow manufacture of devices of appropriate configuration and size with cooling and aging of the mixture until the device is obtained.

In one of the options for the method of manufacturing devices are used, for example: water or its solutions as a solvent, calcium chloride as a low-molecular electrolyte, the concentration of which does not exceed 5 mol/l, and gelatin as a polyelectrolyte, the total weight of which is from 5 to 50%. At the same time, dissolution of gelatin in electrolyte is carried out until its total completion under conditions of gradual heating. Under the conditions of the selection of the above-mentioned components, physical (thermo-reversible) hydrogel includes a compound of gelatin with calcium chloride as complexes.

### A BRIEF DESCRIPTION OF THE DRAWINGS

FIG. 1. Cleaning device from a hybrid physical thermoreversible hydrogel of polyelectrolyte and its complexes with salt ions

FIG. 2. The main structural elements of the compartment for the manufacture of pigs

### DETAILED DESCRIPTION OF THE INVENTION

A review of inventions related to technology of cleaning pipeline interior with help of cleaning devices showed that the vast majority of them require use of launching and receiving chambers. In addition, threat of clogging of interior in case of stopping device remains unresolved. Presence of some positive quality is often accompanied by presence of negative ones. Thus, mechanical rigid devices provide the best removal of solid deposits, but they often clog pipeline interiors and require mandatory use of cameras. The idea of using self-destructing devices looks very attractive.

I had to refuse from use of gas hydrates for manufacture of self-destructing devices, because technology be found complexity, and the devices were no elastic; in addition, regulation of operational time is provided only at manufacturing stage. The last disadvantage involves manufacture of cleaning devices one by one for each of pipelines, which have different lengths, different operating conditions, for example, in gas collection pipelines in the same production.

My idea of cleaning method includes availability at a time such device qualities as follows: self-destructivity, adjustment of service life in conformity with operating conditions, reliability, elasticity, possibility of long-term storage, universality due to possibility of use for pipelines of different lengths owing to additional regulation of service life after manufacturing; problem was solved on basis of hybrid (thermo-reversible) hydrogel of polyelectrolyte and its complexes with salt ions.

More specifically, in the claimed invention the structure of the device is hybrid physical thermo-reversible hydrogel of polyelectrolyte and its complexes with salt ions, which contain inclusions of polar solvent with polyelectrolyte and salts.

The method of cleaning pipeline interior includes passage of the cleaning device from hybrid physical hydrogel, during which deposits, contamination or liquid are removed and pushed to end of linear part of pipeline, destruction and dissolution of the device, removal of remains of the device along with impurities and liquid from the pipeline. A peculiarity of the method is that melting temperature of the gel is lower than temperature in pipeline.

Composition of material for cleaning device should ensure its destruction before reaching end of pipeline need cleaning. Determination of component parts for a composition is based on time of movement of the device and speed of its heating from initial temperature to melting temperature. It is desirable that complete melting of the device coincides in time of its arrival at the pipeline end. If it is necessary to clean significant number of pipelines, it is not desirable to adjust composition of device separately for different conditions and to produce devices individually. To prevent this, additional regulation of operation time (service life) of the cleaning device before launching is provided by changing the degree of its supercooling relative to melting temperature. At the same time the service life of manufactured series of devices should correspond to the smallest value in accordance with the shortest length of the pipeline and the highest current speed of movement.

The gel from which body of the device is made has visco-elastic properties, and its elastic keeps not only in time of launching but also during further movement through the pipeline. Device is able to withstand mechanical influences and retain its original shape.

As its temperature gradually rises, it passes into an ointment-like viscous-plastic state. When the melting point is reached occurs gel-sol transition in viscous-liquid state. The final stage of transformation of the device into a liquid ensures flowing one from the end of the pipeline to another part of the system or apparatus, even through significant narrowing.

Thus, destruction occurs in certain period of final stage of device using, which often comes into contact with liquid, for example, water or oil.

Two main variants of process of launching pigs are possible in dependence from available equipment at the pipelines need cleaning.

Usually, cleaning devices made of polymers and metals are launched into pipelines using special cameras of stationary or mobile types. Such chambers can also be used for launching self-destructive devices. In case absence of chambers, it is possible to manufacture the pig directly at the launcher site if are available the favorable operating conditions for this in form of a compartment or pipe-bend.

The compartment for manufacture of the pig must be filled with molding mixture. Its preparation and transfer to compartment at the launcher site are carried out with mobile equipment; the mixture must be transported with auxiliary container in case using of stationary version.

Thus, it can be cleaned sections of pipelines with self-destructive device, even if they do not have neither pig launching, nor receiving chambers at all.

Use of self-destructing pigs in pipelines containing water is promising, namely: water pipelines and distribution networks of water supply systems, pipelines of various purposes at construction stage during hydraulic tests, gas well loops on gas fields, gas storage loops and many others. After melting of pigs its remains dissolve in water and are removed with it.

Sometimes pipeline interior cleaning is performed at the “open end”, when pig is removed from system along with water and impurities after use. In this case, advantage of self-destructive soluble pigs consist in absence of need searching for place of blockage at its stop, cutting and restoration tightness of the pipeline, etc. After a certain period of time, the passage in the pipeline will open as a result of the destruction of the device and cleaning works to interior can be continued. This technology looks promising for use in urban conditions, when elimination of blockage is associated with difficulties of earthwork's fulfilment.

In number of cases, it is possible to liquidate the pig in the pipeline system, for example, at gas field, in separators, pipelines with larger diameter than one that need cleaning.

Use self-destructive pigs looks also promising at gas fields during period of falling gas production. Required pressure drop in gathering pipelines at underground gas storages is makes by venting gas into atmosphere with pneumatic controllers; this leads to losses, damage the environment, but don't reduce hydraulic resistance of line (Oil and Natural gas sector pneumatic devices, 2014).

The possibility of pipeline interior cleaning with guaranteeing of blockage absence should be particular interest to field of production in offshore areas.

Self-destructive pigs also have prospect of being used in pipelines of oil and oil products.

Work was carried out on testing a pattern of self-destructing pig in conditions of gas production. The collector had 8-km long and 530-mm diameter. The pipeline was cleaned of water condensate without gas loss to the atmosphere, and the pig was passed without any technological complications, and its decomposition took place in dead end before gas treatment plant ( [symbol] , 2012).

The material of the device intended for use in the pipeline interior cleaning method, which is claimed, is a highly concentrated hybrid physical thermoreversible hydrogel of polyelectrolyte and its complexes with salt ions A highly concentrated gel provides the possibility to manufacture devices of complex configuration in contrast to ordinary liquid gels, and significantly expands the technological possibilities of their use in combination with property of melting.

The body of the pig is made in the shape of bullet, which is equipped with central longitudinal conical channel that narrows in direction from rear end to nose part. During movement part of transported current flows from space behind the device to space in front of nose part. The current in channel makes it possible to influence on rate of heating of pig body in direction from center to periphery, and therefore on rate of destruction due to both melting and removal of melt.

If a solid pig is used, blocking of interior will be possible. When it comes to end of linear part of section of pipeline that is subject to cleaning, but does not reach complete melting. Therefore, presence of channel in self-destructive pig increases reliability of cleaning method due to possibility of reducing the time of its destruction and simultaneously increasing the time of working capacity. Temperature of pig gradually increases while movement through the pipeline. When the melting temperature is reached in its center, the diameter of the channel little by little increases, begin slowing down the speed of movement and the melting of all device is accelerated.

In addition, the jet from the nose part of pig supports sediment particles in form of suspension and does not allow them to get stuck in plug, which can cause blocking of pipeline; and even more, there is a better cleaning of inner surface due to hydromechanical effect.

The mechanical properties of the highly concentrated gel material provide the possibility of manufacturing devices with complex configuration, which is more efficient than cylindrical one, and in combination with the property of melting significantly expands the technological possibilities of their use.

Also, the invention is based on the task of developing a method of manufacturing a cleaning device with a required melting temperature that meets the conditions of use.

The method was supposed to provide, namely: an increase in reliability of the device in sense of the possibility of timely complete destruction, its suitability for long-term storage, universality (wider conditions of use). The task is solved by using for a self-destructive device hybrid physical thermoreversible gel of polyelectrolyte and its complexes with salt ions, which content inclusions of initial aqueous solution of polyelectrolyte and salt captured as a result of occlusion; the melting temperature of this gel is lower than the temperature in cleaned pipeline.

The production method consists in preparative of mixture of polyelectrolyte, solvent and low-molecular electrolyte (for example, salt of a divalent metal) with stirring, accompanying heating (if necessary), as a result of which the components gradually dissolve, reaction occurs between polyelectrolyte and electrolyte with making of a forming mixture of metal-carboxyl ligand complexes, solution of polyelectrolyte and salt, and subsequent pouring of the forming mixture into molds of appropriate configuration and size (if necessary, pre-cooled), and reducing solubility of solvent, for example, by cooling the mixture until formation of a gel of hybrid structure, and mixture aging until the device is produced.

The composition of the material from which the cleaning device should be made dictates the conditions of its use. Thus, the time of operation of the device (staying in interior) is determined, first of all, by the length of area to be cleaned and the speed of the device; the latter is also affected by condition of inner surface, by amount of deposits, garbage, etc. For example, in gas pipeline, the cleaning device lags behind gas current due to gas flow through the nozzle and its speed that can decrease by approximately to 20%. Based on the temperature in pipeline, it is possible to set the melting temperature of the material (it should be lower) and the composition corresponding to it. In addition, supercooling of the device relative to the melting temperature until moment of launching ensures stability of the structure, increases its strength and provides the possibility of additional regulation of the operational time by increasing it, ensures its destruction at right moment.

Regulation of the melting temperature of material of the cleaning device (e.g. its reduction) can be carried out using “perturbants”, destroyers of the structure of macromolecules, which can also affect the structure of polyelectrolyte gel. The most attractive is use of inorganic salts.

From field of chemistry and physico-chemistry of polymers it is known that inorganic salts affect properties of macromolecules in solutions (stability, solubility, biological activity) in various ways within wide limits (Hippel and Schleich, 1969).

Already initial observations of melting temperature of gelatin gels (Bello et al., 1956) showed that significant difference in effect of different ions on melting temperature is due to difference in interactions between ions and gelatin. In experiments performed with 5 percent gelatin aqueous solutions, salting out salt (e.g. sodium chloride) reduce temperature of formation of gels due to their ability to form aqueous structures.

It was found recently (Sarabia et al., 2000) that melting point of gelatin gels was significantly increased by addition of MgSO₄, (NH₄)₂SO₄, and NaH₂PO₄ while chlorides acted to decrease it. A similar phenomenon was observed, when the addition of CaCl₂ led to decrease in melting temperature of gelatin gels, while CaSO₄ tended to increase it (Sarbon et al., 2014).

Interaction of proteins and salt solutions generally significantly depends on ionic strength value, below or above ˜0.1M (Ciferry, 2008).

At low concentrations salts stabilize proteins and other polyelectrolytes (Tanford, 1961), and at high concentrations they cause specific effects depending on their nature and concentration (salting in or salting out, precipitation or crystallization, stabilization or denaturation).

Monovalent counterions attach to polyelectrolytes only due to Coulomb attraction; result of their presence only creates screen that interferes electrostatic interaction between polyelectrolytes.

However, conditions are significantly different for multivalent counterions. They also screen polyelectrolytes but with more significant effect than monovalent ones, and, in addition, they can selectively bind to ionic groups on polyelectrolyte chain, which is accompanied by complexation of multivalent counterions and polyelectrolytes.

Early studies of the influence of salts on swelling and phase transitions of isoelectric proteins at ionic strengths well above 0.1 M confirmed correctness of classification of anions and cations according to the Hofmeister series (Hofmeister, 1888). Depending on the effect solutions were initially labeled with terms “kosmotrope” (from the Greek “order”) and “chaotrope” (from the Greek “disorder”), which respectively stabilized and destabilized proteins and membranes. Chaotropes unfold proteins, destabilize hydrophobic aggregates and increase their solubility, whereas kosmotropes stabilize proteins and hydrophobic aggregates in solution and decrease hydrophobic solubility (Chaplin, 2012). In general, the ionic behavior is parallel to the Hofmeister series. Large singly charged ions with low charge density that exhibit weaker interactions with water are chaotropes, while small or multi-charged ions with high charge density are kosmotropes that exhibit stronger interactions with water molecules than water molecules with each other and are therefore capable of breaking hydrogen bonds, connections between water molecules.

Ions are distributed by properties in order of increasing degree of hydration into the series of anions CNS⁻<ClO₄⁻<I⁻<NO₃⁻˜Br⁻<Cl⁻<F⁻<H₂ PO₄⁻<S₂ O₃²⁻<SO₄²⁻, and the series of cations Li⁺<Na⁺<K⁺<Mg²⁺<Ca²⁺<Ba²⁺. Anions on the right side of the series are cosmotropic, and anions on the left are chaotropes. In accordance with ability to hydration ions increase positive effect on process of formation of gels. The influence of cations is significantly smaller than that of anions, and their sequence is not so sharply defined ( [symbol] , 1968).

Although stabilizing or destabilizing effect caused by salts in inducing conformational transitions of macromolecules occurs according to the Hofmeister series (Lo Nostro and Ninham, 2012; Collins and Washabaugh, 1985; Liu et al., 2008), consequences depending on valence of ions (Jianlong et al., 2017) and their size (Chatterjee and Bohidar, 2005) differ significantly.

Sodium chloride ions have little effect on structure of aqueous gel of gelatin even at significant concentration (Wu et al., 2018). Unlike monovalent ions, ions of divalent metals such as calcium, copper, zinc, and cobalt can form ionic bonds with carboxylic acid groups of gelatin polypeptides (Xing et al., 2014). Preferential interaction of proteins with solvents in concentrated aqueous solutions of sulfates, acetates, and chlorides of salts Mg²⁺, Ba²⁺, Ca²⁺, Mn²⁺, and Ni²⁺ was studied, and the results were compared with those obtained for Na⁺ (see Arakawa and Timasheff, 1984). It was found that for all salts hydration mainly grew in order Cl⁻<CH₃⁻<COO⁻<SO₄²⁻ regardless of differences in the used cations in agreement with anionic lyotropic series and that the same parameter reveals a growing trend in order Mn²⁺, Ni²⁺<Ca²⁺, Ba²⁺<Mg²⁺<Na⁺.

Thus, anions and cations from right side of the Hofmeister series increase solubility and denaturation due to salting in due to their preferential adsorption to proteins, and from left side cause opposite effect of salting out due to deterioration of interaction between protein and bulk solution. Unequivocal evidence provided for these distributions through classic study of initial and final salt concentrations in aqueous solutions before and after equilibration with gelatin gel (Docking and Heymann, 1939). The results of this work allow us to conclude that among alkaline earth metal ions (Mg⁺⁺, Sr⁺⁺, Ca⁺⁺, Ba⁺⁺) calcium ion adsorption exceeds adsorption indicators of magnesium and strontium ions and it is almost the same as that of barium

A review of literature allows us to conclude that the most studied gel-forming substance is gelatin, however, the most attention was paid to process of physical gel formation. But there is very little information about effect of salts on formation of gels and their properties. It is possible to cite only two works in which was investigated effect of cation size on formation temperature of gelatin gels and its viscoelastic properties (Chatterjee and Bohidar: 2005 and 2006). It should also be noted that all studies are mainly devoted to structure of gels, determination of formation temperature and rheological features, while they were often conducted with low concentrations of gelatin solutions, and gels were formed in static conditions.

Gelatin and calcium chloride react to form complexes due to formation of ionic bonds during interaction of divalent metal ions with carboxyl groups of gelatin polypeptides.

The applicant of this invention experimentally investigated conditions for formation of complex gels of gelatin and calcium chloride in highly concentrated solutions and determined their melting temperatures ( [symbol] A. C., 1987, not publ.). Many pipelines are operated at temperatures lower than 20° C., and so urgent task is ensuring of pig destruction and their performance, accordingly, with conditions of significantly lower temperatures.

Possibility of carrying out reaction of formation of complexes in highly concentrated solutions of polyelectrolyte and salt by conditions of mechanical influence in a capacitive reactor (0.4 m3) of batch type with ribbon mixer was experimentally proven; it is used gelatin and calcium chloride when their total mass part in solution reaches 0.4 and even exceeds this indicator.

It is shown that at 20° C. gelatin gel with a concentration of 18% in presence of 1M Ca²⁺ turns into a solution, which indicates impossibility of using process of gel formation in such conditions (e.g. see work Wu et al., 2018).

In work ( [symbol] A. C., 1987, not publ.), it was proved that it is possible to carry out reaction of formation of highly concentrated gelatin gels even at higher concentrations of Ca²⁺, but with a significantly higher content of gelatin and temperatures below 20° C., including negative ones.

To ensure formation of gelatin gels with increasing of concentration of calcium chloride, it is necessary essentially to lower temperature, increase solution's exposure time, or apply both actions together.

Studies of purely aqueous polymer gels proved the existence of three forms of water in them: free, bound and intermediate (differently: free, strongly and weakly bound). See, for example: Aizowa et al., 1973; Hatakeyama et al., 1995: Akiyama et al., 2007: Gunko et al., 2017. When they are frozen, bound water shows inability to crystallize up to −30° C. (T<260-265K), while free water freezes like bulk phase at 0° C. (273K). Intermediate water is more bound to gel structure than free water and therefore less mobile than the latter; it does not freeze at 260-265<T<273K.

The data given above coincide with those obtained experimentally for a number of polymers (Tovbin et al., 1976). In the state of their greatest swelling crystallization temperature of water is from −6.5 to −7.5° C.

When gel is formed from aqueous solution of salt, it will be elastic at some negative temperature if salt concentration is sufficient to prevent freezing.

Strength indicators of gels are directly dependent on amount of free water and significantly deteriorate with its increase, so this fact must be taken into account when determining composition of material of self-destructing devices.

Observations of changes in structure of pure gelatin gels (Wu et al., 2018) showed that there are two phases in gelatin gel, namely: the “dense phase” of clusters and cell-like network of “rare phase” consisting of triple helices and curls, ratio between which depends from gelatin concentration and determines mechanical qualities. It is clear that some increase of cluster concentration and indicators of gel strength are directly dependent from some increase of gelatin concentration.

As mentioned above, pipeline cleaning often needs to be carried out at temperatures significantly lower than 20° C. Salts are used to lower melting point of gels, but this is accompanied by decrease in number of triple helices in the composition, and therefore in terms of strength. However, the need to significantly lower temperature for formation of gels makes it possible to compensate for this phenomenon.

In the final stage of production of self-destructing device by forming gel and fixing its structure, forming mixture is cooled in casting molds of an appropriate configuration and size. Forms can be cooled in advance, before start of filling, if it is necessary to speed up manufacturing process; their subcooling is also used to increase service life of device with simultaneously compensation for strength reduction.

Provided that necessary temperature conditions are maintained, it is possible to store devices for long time.

Homogeneity and strengthening of the material occur in entire volume thanks to mixing, so a need for other operations, for example, reinforcement of device outer layer disappears. Melting temperature of pigs is primarily regulated at stage of their manufacture by changing ratio of reactants volumes without significant changes in technology, and so nomenclature of used components remains unchanged. The service life can be additionally adjusted due to degree of subcooling of finished product; they will be suitable for use in wide range of temperatures (more universal). As result for manufacture of devices it becomes possible to use an equipment with significant productivity and no necessarily locate it at place of application, but where it is due to economic considerations. Storage and transportation of products to launcher site is significantly simplified in cold periods of year.

The method of manufacturing devices makes significant contribution to economic effect of its use both in the case of using casting molds and in the case of manufacturing ones directly at the launcher site.

Improvement of the strength indicators of the composition is achieved due to the use of hybrid gels of high concentration and additionally by a degree of subcooling of the device relative to his melting temperature. Thus, the material of entire body is strengthened, and its properties ensure the possibility of long-term storage.

By selection of derivatives for the manufacture of cleaning devices the pair of gelatin-calcium chloride components are looks the most attractive from practical point of view. They belong to multi-tonnage environmentally safe materials and are widely used in various fields of industry, medicine and household. The use of these substances is not accompanied by harmful effect on the environment.

It is preferable to use water as a solvent. It is also possible to use mixed solvents, for example, water mixed with formamide, glycerin, etc. ( [symbol] ., 1971).

Gelatin is produced from collagen, which is the main component of some connective tissue of vertebrates, for example: skin, bones, tendons. The technology is based on boiling some raw material and then product extracting from broth by forming gel and drying it ( [symbol] , 1951).

Recently, gelatins produced from marine fish skins were considered as an alternative to using mammalian gelatins (Sarabia et al., 2000). Studies of their properties and ways of improving the technological qualities of gels are being conducted, including salts using.

Calcium chloride is obtained as a secondary product in production of soda. It is extremely widely used in various fields of production, namely: metallic calcium, drying of natural gas, in milk processing, in medicine, etc. (Ty 6-09-5077-83 « [symbol] »; [symbol] , [symbol] , T.2, 1964).

In addition to calcium chloride, can also be used follow: chlorides, iodides and bromides of divalent metals Mg²⁺, Zn²⁺, Ca²⁺, Sr²⁺, Ba²⁺, which can lower the temperature of gelatin gel formation (Nobel, 1951), or Co²⁺, Cu²⁺ (Loeb, 1919; Takagishi et al., 2006), etc.

It is known that such chlorides as NaCl, MgCl₂, KSCN lower the melting point of gels, and raise so as: MgSO₄, (NH₄)₂SO₄, NaH₂PO₄ (Arakawa, Timasheff, 1982), as well as salts with cations of the above series according to (Arakawa and Timasheff: 1984 and 1982). Thus, if necessary to increase the melting point of the material, it is possible introducing into the composition salts, which are the last in this list.

The selection of the composition of the device material is carried out by determining polyelectrolyte-electrolyte ratio in the solution at the manufacturing stage, which makes possibility to use the cleaning method in various conditions, that is gives versatility.

The dependence of the melting temperature of highly concentrated gelatin gels from the concentration of calcium chloride was determined experimentally ( [symbol] A. C., 1987). The results of research are used in examples of implementation of the invention.

The essence of the invention is explained with following examples.

### Example 1

It is necessary to remove water and pollution from an interior of a gas gathering pipeline, in which temperature is +15° C. First, a composition of a self-destruct device should be determined. Taking into account the conditions of use, its melting temperature should be 2° lower than temperature in the interior, that is equal to 13°. For a gelatin gel with a concentration of 18% with such melting temperature, a molar concentration of calcium chloride is found according to the formula: Cmo=(28.5-Ts)/16.82, in which Ts is a melting point of a gel with salt ( [symbol] A. C., 1987). Based on the calculation, we obtain the chemical compound, which includes following ingredients, wt. %: water—72.5; calcium chloride—9.5; gelatin—18.0.

Calculations were made with condition of using certain components: gelatin brand is T-11, technical, manufacturer plant “Svema” (Ukraine) ( [symbol] OCT 4821-77 « [symbol] »; [symbol] OCT 1129-78 « [symbol] , [symbol] »); dihydrate calcium chloride (TY6-09-5077-83); drinking water ( [symbol] 2874-82 « [symbol] , [symbol] »). [symbol] »).

The following operations are fulfiled to manufacture the self-destructing device. According to the calculation of the necessary quantity of self-destructive material and its composition, a stirring apparatus is filled with water, into which is introduced calcium chloride and dissolved with continuous mixing (and heating). Gelatin is gradually added to solution, swells and dissolves in the conditions of stirring and continuously raising of temperature to 35-40° C. The heating process continues until its complete dissolution and further to reduce viscosity of the solution. Gelatin and calcium chloride react with forming of calcium-carboxyl ligand complexes due to ionic bonds during interaction of divalent metal ions with the carboxyl groups of gelatin polypeptides. Triple helices and calcium-carboxyl ligand complexes accumulate in mixture. When temperature of the mixture reaches 40-45° C., it can be poured into molds for production of cleaning devices. The final operation is cooling in the casting mold to the temperature of −3° C. and waiting for the product to acquire strength for at least 6 days, which corresponds to the manufacturing conditions, after which the product can be stored at temperatures below the melting temperature (or at required pig launching temperature). To accelerate fixation of mixture structure, the mold can be pre-cooled before filling, and after filling with the mixture it can be kept at temperature below the melting point of the material.

“Apparatus with mechanical stirring equipment enameled” (Ty 26-01-678-85), produced by the Chernivtsi plant “Emalposud” (Ukraine), or similar to them, can be used to prepare the forming mixture. The stirring equipment includes an electric motor, which with help of a planetary gearbox rotates the mixer at frequency of 75 rpm. The stirring is done slowly using mixers that are used for highly viscous liquids, for example, ribbon ones. Heating of the components in the stirring apparatus is fulfiled due to circulation of coolant through a heating jacket with which it is equipped. The finished mixture is removed from the stirring apparatus through a lower outlet. If it is necessary to clean pipelines of considerable length, the cleaning device is supercooled according to calculations.

### Example 2

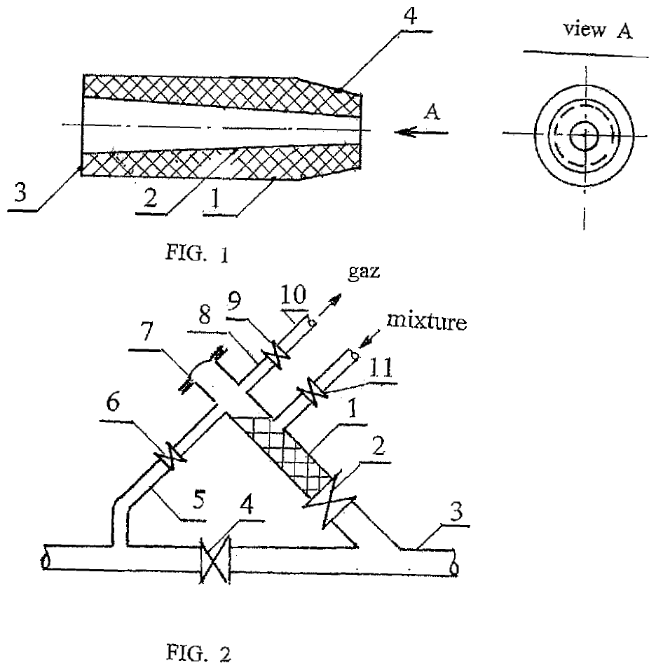

A cleaning device made of a hybrid physical thermoreversible hydrogel of polyelectrolyte and its complexes with salt ions is highly concentrated, and the body 1 is made in the shape of a bullet, which is equipped with a central longitudinal conical channel 2, which narrows in direction from the rear end 3 to the nose part 4 (FIG. 1).

During movement, part of transported stream flows from space behind the device to space in front of nose part. The flow in the channel makes possibility allow to influence on rate of heating of pig body in direction from center to periphery, and therefore on rate of destruction both due to melting and erosion. If a solid pig is used and it no reaches complete melting before arriving at end of cleaning section of pipeline, interior clogging will be possible. Therefore, the presence of channel in the pig increases its reliability due to possibility of influencing on a service life and cleaning method in general.

In addition, jet from nose of the pig does not allow particles of sediment to press in a cork, which can cause clogging of pipeline. The flow supports the particles deposits in form of a suspension, and even more so, promotes better cleaning of inner surface due to hydromechanical effect.

### Example 3

Cleaning of interior of pipeline in absence of stationary chamber.

It is possible to manufacture a pig at starting point, if it is provided a compartment as a mold with suitable auxiliary pipes. The pig are made by filling and keeping forming mixture in the compartment. To be able to supply the mixture to the compartment, it is necessary to have a mobile unit for manufacture of the forming mixture; in the case of use stationary unit the mixture is transferred in an auxiliary tank and transported to launch site. The most attractive option for making a pig in the compartment is use of favorable natural conditions.

The main structural elements of the compartment for the manufacture of pigs are shown in FIG. 2. This scheme allows to make the pig at the place of its launch without stopping of the pipeline on example of gas transportation. Compartment 1 through the valve 2 is connected to the cleaning pipeline 3, behind the valve 4 on the pipeline along flow. The compartment is mounted at angle to the pipeline to be able to control length of the pig and convenience of its launching. The compartment is equipped with a nozzle for purging 8 and supply line 5 of part of the flow transported by pipeline.

When the pipeline is running, valve 4 is open and the valve 2 and shut-off valve 6 are closed. To manufacture the pig first open shut-off valve 9 on purge nozzle 8 and valve 11 on nozzle to fill the compartment 1. A portion of the mixture delivered to launching point is fed into compartment 1 through the valve 11. Valves 9 and 11 are closed. The mixture is kept in the compartment until formation of the pig.

To launch the pig in pipeline 3 first opens valve 6 to equalize pressure in the compartment and the pipeline. Valve 2 opens, and then slowly closes valve 4 on the pipeline so pressure in the compartment gradually increases and the pig is pushed into pipeline 3.

In absence of chambers on a number of pipelines, when there is possibility of temporary stopping of product transportation.

Under favorable conditions, if piping allows the pig to be made directly at the launch point, it is possible to carry out cleaning work without a compartment with minimal installation costs.

Thus, the unique qualities of self-destructive devices allow to clean sections of pipelines that do not have stationary chambers (neither for launch pigs, nor receive), both with the use of the compartment and even without it.

### Example 4

Interior cleaning if a pipeline is equipped with a pig launcher chamber.

A composition with the required time of use in the pipeline (Example 1) is obtained in the stirring apparatus, from which a self-destructive cleaning device is made in mold of the appropriate configuration and size. Subsequently, the device is removed from the mold, moved to the launch chamber, the device is passed through the pipeline, in which deposits (or liquid) are transported before the device to the end of the pipeline, the device is destroyed and dissolved, and its remains with liquid are removed from the linear part pipeline. Removal of liquid with the remains of the device can be implemented depending on the purpose of the pipeline as follows:

a) inside of cleaned pipeline; b) outside open end of cleaned pipeline; c) inside a separator; d) inside a pipeline, the diameter of which larger than cleaned one, etc.

What is claimed is:

1. A method of cleaning pipeline interiors including passage of a cleaning gel device through said pipeline to contact the interior wall, in which deposits, impurities, liquid in diverse combinations are removed and pushed to pipeline's end, destruction and dissolution of the device, removal of device remains together with impurities and liquid from said pipeline, and said device has structure of a hybrid physical (thermo-reversible) hydrogel of a polyelectrolyte and its complexes with salt ions, with inclusions of a polar solvent with said polyelectrolyte and salt ions, moreover a melting temperature of said device is lower than a temperature of said pipeline interior.

2. The method of claim 1 wherein an operational time increasing of the cleaning device is regulated by a degree of its supercooling relative to said melting temperature.

3. A cleaning device made of a gel, which consists of a hybrid physical (thermo-reversible) hydrogel of polyelectrolyte and its complexes with salt ions, which is high concentration, with inclusions of a polar solvent with polyelectrolyte and salts, and his body is made in the shape of a bullet, which is equipped with a central longitudinal through channel.

4. The device of claim 3, wherein the channel is conical that narrows in direction from rear end to nose part.

5. A method of manufacturing devices, which includes sequential, gradual dissolution of a low-molecular electrolyte, a polyelectrolyte with stirring in a polar solvent, due to which a reaction is carried out, as a result of which a forming mixture is created from said solvent, interaction products of the polyelectrolyte and salt ions that are complexes, a polyelectrolyte, a electrolyte, subsequent pouring of the forming mixture into casting molds, that allow to manufacture the devices of appropriate configuration and size after cooling and aging of the mixture, removal of the devices from molds.

6. The method of claim 5 wherein water is used as the solvent.

7. The method of claim 5 wherein calcium chloride is used as the low-molecular electrolyte.

8. The method of claim 7 wherein the concentration of calcium chloride does not exceed 5 mol/l.

9. The method of claim 5 wherein gelatin is used as the polyelectrolyte.

10. The method of claim 9 wherein weight concentration of gelatin in forming mixture is from 5 to 50%.

11. The method of claim 9 wherein dissolution of gelatin carried out until its total completion in conditions of gradual heating.

12. The method of claim 5 wherein the forming mixture includes a compound of gelatin with calcium chloride as the complex.

13. The method of claim 5 wherein dissolution of the polyelectrolyte in the solvent is fulfiled before dissolution of the low molecular weight electrolyte.

14. The method of claim 5 wherein the forming mixture is poured into the pipeline compartment, which is intended for forming and launching the device (pig) into pipeline's linear part.

15. The method of claim 14 wherein the pipeline compartment is equipped with a case for artificial cooling.

16. The method of claim 1 wherein stationary chamber is used for launching the cleaning devices, which manufactured in separate equipment.
